(19) United States
(12) Patent Application Publication
(10) Pub. No.: US 2007/0049705 A1
(43) Pub. Date: Mar. 1, 2007

(54) Polycarbonate molding compositions having improved rheological properties

(75) Inventors: Alexander Meyer, Düsseldorf (DE); Frank Buckel, Krefeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/508,073

(22) Filed: Aug. 22, 2006

(30) Foreign Application Priority Data
Aug. 26, 2005 (DE) 102005040464.2

(51) Int. Cl. C08L 63/00; C08L 69/00; C08G 59/00; B32B 27/38

(52) U.S. Cl. 525/463; 525/523; 528/87

(57) ABSTRACT

An epoxy resin conforming to formula (I) 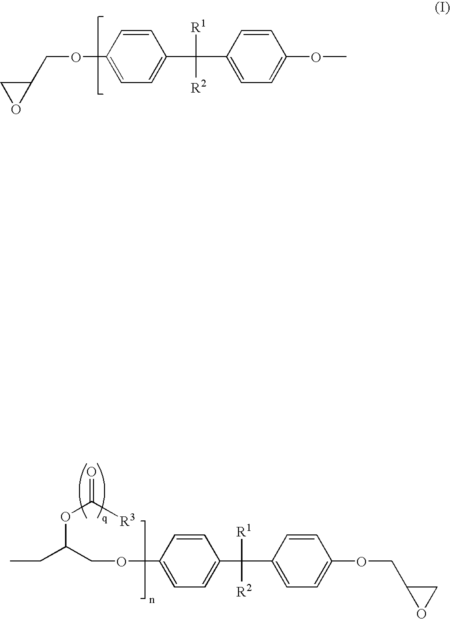
wherein R¹, R²R³n and q are defined is disclosed. Also disclosed is a thermoplastic polycarbonate molding composition that contains the epoxy resin. The composition is distinguished by improved rheological properties with otherwise comparable optical properties.

### FIELD OF THE INVENTION

The invention relates to thermoplastic molding compositions and in particular to composition containing polycarbonate.

### TECHNICAL BACKGROUND OF THE INVENTION

For processing of polycarbonates or polyester carbonates, these should have particularly good flow properties. An improvement in the flow properties of polycarbonate or polyester carbonate may be achieved by various measures. The simplest is reduction of the molecular weight, which, however, is associated with a deterioration in the mechanical properties, such as e.g. the impact strength, and in particular the notched impact strength.

The flowability of polycarbonate may furthermore be increased via low molecular weight additives. In JP-A 2001226576, a polycarbonate having a low molecular weight is added to a polycarbonate of higher molecular weight. Nevertheless, in general these low molecular weight additions may lead to the reduction of optical quality, such as e.g. the transmission or the yellowness index (YI). Furthermore, low molecular weight additions often cause deposits on the injection-molded parts (plate-out) and in this way reduce the quality of the injection-molded article. The mechanical properties of the polycarbonates may moreover be greatly reduced by these additions, as a result of which an important material advantage for the use of polycarbonate is lost.

Via specific comonomers, the flowability of the resulting copolycarbonates may likewise be improved compared with conventional bisphenol A (BPA) polycarbonate. Nevertheless, this is often associated with a change in the spectrum of properties. Thus, the glass transition temperature may be significantly reduced. As described by J. Schmidhauser and P. D. Sybert in J. Macromol. Sci.-Pol. Rev. 2001, C41, 352-367, the use of bis-(4-hydroxy-phenyl)dodecane leads to an extremely low glass transition temperature of 53° C. in the resulting polycarbonate. Copolymerization of BPA with various aliphatic dicarboxylic acids, such as is described e.g. in U.S. Pat. No. 5,321,114, likewise leads to a reduction in the glass transition temperature. WO 2002/038647 discloses the use of long-chain alkylphenols as chain terminators in order to improve the flowability.

Generally, these modified polycarbonates are very expensive to prepare and are therefore associated with high costs. The specific comonomers and/or molecular weight regulators are often not commercially available and must be synthesized by expensive means.

A further possibility for improving the rheological properties of polycarbonate is the use of polycarbonate blends, i.e. mixing of polycarbonates with other polymers, such as e.g. polyesters. Such mixtures are described, for example, in JP-A 2002012748.

Nevertheless, the polymer properties of these polycarbonate blends in some cases differ significantly from standard bisphenol A polycarbonate and are thus not without limitation for the same field of use. Thus, the heat stability, the optical properties, the heat distortion stability (lowering of the glass transition temperature) and the mechanical properties in some cases differ significantly from those of standard polycarbonate.

Mixtures of epoxy resins with industrial thermoplastics, such as e.g. poly(methyl methacrylate) and/or polycarbonate, have been described, e.g. by E. M. Woo, M. N. Wu in Polymer 1996, 37, 2485-2492. These epoxy resins differ significantly from the compositions according to the invention. E. M. Woo et al. report a harmful influence, in particular of epoxy resins which contain hydroxyl groups, on polycarbonate. When the blend is exposed to heat, a degradation of the molecular weight occurs. This harmful influence is not observed with the blends described here.

In U.S. Pat. No. 3,978,020, certain epoxide compounds are employed in combination with phosphorus compounds for modification of polycarbonate. These epoxide compounds according to the invention U.S. Pat. No. 3,978,020 differ structurally from the epoxy resins of the general formula (I) of the present invention.

EP-A 718 367 discloses mixtures of epoxy resins, which differ structurally, however, from the epoxy resins according to the invention, with aromatic polycarbonates. These compositions are distinguished by a high corrosion resistance.

In DE-A 2 400 045, specific aromatic or aliphatic epoxide compounds are used in polycarbonate compositions in order to improve the stability to hydrolysis at elevated temperatures.

DE-A 2 019 325 discloses polycarbonate mixtures comprising polycarbonate and pigments containing epoxide groups. The epoxide compounds are employed in amounts of from 5 to 100 wt. %, based on the pigment content, and as a result are largely stabilized against degradation by moisture.

DE-A 2 327 014 discloses polycarbonates which contain quartz mineral and/or TiO₂ as a filler and comprise a vinyl polymer containing epoxide groups, as a result of which the degradation of the molecular weight is prevented, with virtually unchanged mechanical properties.

JP-A 63117030 discloses epoxy resins which are modified with phosphinic acid derivatives. Nevertheless, these epoxy resins differ significantly from the epoxy resins described here. Furthermore, the substances described in JP-A 63117030 were not employed in polycarbonate.

JP-A 63271357 discloses epoxy resins modified by hydroxyalkyl. Nevertheless, these epoxy resins differ structurally from the epoxy resins described here. Furthermore, the substances described in JP-A 63271357 were not employed in polycarbonate.

The compositions described in the prior art indeed in some cases improve the flow properties of the particular polycarbonate, but at the same time the optical properties, such as transparency, transmission and the yellowness index (YI), as well as other properties, such as, for example, the “plate-out” behavior, deteriorate. The use of such additives in polycarbonate is therefore not suitable for the production of large-area, transparent injection-molded articles, such as e.g. diffuser screens.

The object of the present invention is therefore to provide a polycarbonate composition having improved flow properties while simultaneously retaining the optical properties and good processability. It has been found, surprisingly, that compositions of polycarbonate and specific oligomeric epoxy resins have excellent flow properties with simultaneously good optical properties.

### SUMMARY OF THE INVENTION

An epoxy resin conforming to formula (I) 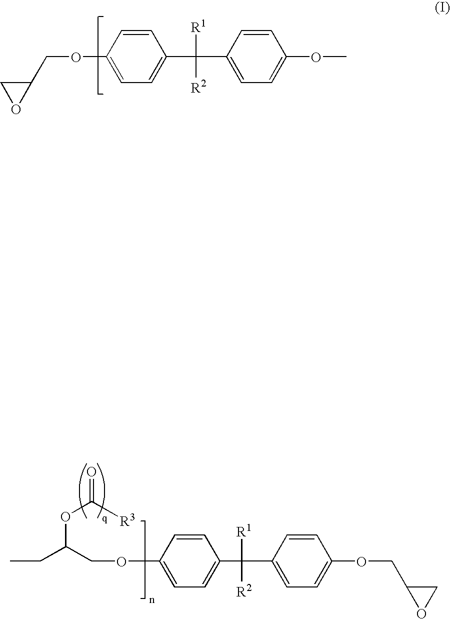
wherein R¹, R², R³ n and q are defined is disclosed. Also disclosed is a thermoplastic polycarbonate molding composition that contains the epoxy resin. The composition is distinguished by improved rheological properties with otherwise comparable optical properties.

### DETAILED DESCRIPTION OF THE INVENTION

The present invention therefore provides the oligomeric epoxy resins of the formula (I) 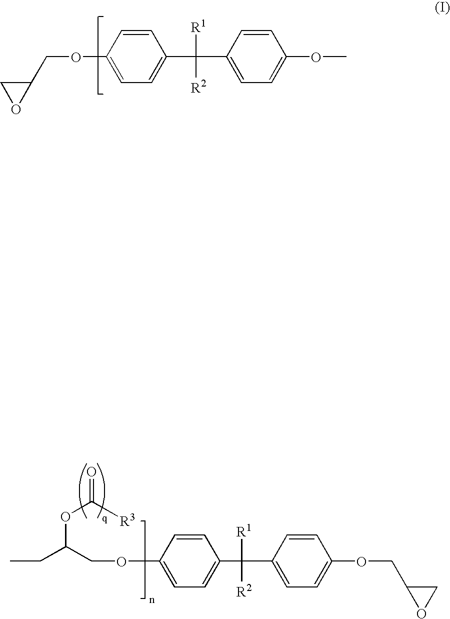
wherein
R¹, R² independently of one another denote H, a C₁-C₁₂ alkyl, phenyl or benzyl radical or, together, a cyclic C₅-C₁₂-alkyl radical, preferably H or methyl or, together, the cyclohexyl radical,
R³ represents an optionally substituted aryl, benzyl, linear or branched C₁-C₁₈ alkyl or cyclic C₅-C₁₂-alkyl radical,
n represents a number-average value of 0.5-20, preferably a number-average value of 1-9, particularly preferably a number-average value of 1-4, and
q is 0 or 1, preferably 1.

The use of the oligomeric epoxy resins according to formula (I) as flow agents in polycarbonate or polyester carbonate is advantageous.

The present invention therefore also provides compositions comprising
A) 95 to 99.9 wt. %, preferably 97 to 99 wt. % of polycarbonate and
B) 0.1 to 5 wt. %, preferably 1 to 3 wt. % of epoxy resin of the formula (I).

Also disclosed is the preparation of a masterbatch by incorporation of the oligomeric epoxy resin in polycarbonate in an amount of 5 to 20 wt. % relative to the weight of the Masterbatch. Also disclosed is a process for making a composition by mixing an amount of Masterbatch with polycarbonate in the form of a melt or solution, the amount calculated to result in a polycarbonate composition containing the oligomeric epoxy resin in an amount of 0.1 to 5 wt. %, preferably 1 to 3 wt. % relative to the weight of the composition.

The present invention also provides the use of the composition according to the invention for the production of extrudates and shaped articles of all types.

The composition according to the invention is advantageously used for the production of optical data carriers and glazing.

The present invention also provides the extrudates which comprise the composition according to the invention.

The present invention also provides the shaped articles which comprise the composition according to the invention.

The components which are suitable according to the invention for the polycarbonate compositions are subsequently explained by way of example.

Component A

The aromatic polycarbonates suitable in the context of the invention may be both homopolycarbonates and copolycarbonates; in this context, the polycarbonates may be linear or branched in a known manner.

As also already described in DE-A 2 119 799, the preparation of polycarbonates takes place with the involvement of phenolic end groups by the interfacial process or also by the process in a homogeneous phase. Aromatic polycarbonate which is prepared by either process may be used in the composition according to the invention.

The preparation of polycarbonate by the interfacial process is described in the prior art, such as in H. Schnell, Chemistry and Physics of Polycarbonates, Polymer Reviews, vol. 9, Interscience Publishers, New York 1964 p. 33 et seq. and in Polymer Reviews, vol. 10, “Condensation Polymers by Interfacial and Solution Methods”, and in Paul W. Morgan, Interscience Publishers, New York 1965, Chapter VII, p. 325.

However, the aromatic polycarbonates for the composition according to the invention may also be prepared from diaryl carbonates and diphenols by the known polycarbonate process in the melt, the so-called melt transesterification process, such as is described in WO-A 01/05866 and WO-A 01/05867. At the same time, however, aromatic polycarbonates from transesterification processes (acetate process and phenyl ester process) such as are described in U.S. Pat. No. 3,494,885, U.S. Pat. No. 4,386,186, U.S. Pat. No. 4,661,580, U.S. Pat. No. 4,680,371 and U.S. Pat. No. 4,680,372, EP-A 26 120 EP-A 26 121, EP-A 26 684, EP-A 28 030, EP-A 39 845, EP-A 91 602, EP-A 97 970 EP-A 79 075, EP-A 146 887, EP-A 156 103, EP-A 234 913 and EP-A 240 301 and in DE-A 1 495 626 and DE-A 2 232 977 may also be employed.

Component B

In the epoxy resins of the formula (I), the index n is preferably selected such that the number average molecular weight of the compound is 340 to 10,000, preferably 700 to 4,000. The number average molecular weight is measured by gel permeation chromatography with a polystyrene standard, THF being use as the solvent and the measurement taking place at room temperature.

The epoxy resins which serve as starting compounds for the preparation of the epoxy resins of the formula (I) according to the invention are known and may be prepared from bisphenol A and epichlorohydrin, as described, for example, in Kirk Othmer “Encyclopedia of Chemical Technology” 4th ed. vol. 9, p. 731 et seq. Commercially obtainable epoxy resins, such as Epikote® 1001 from Hanf+Nelles GmbH Co KG (epoxide content 2,220 mmol/kg; viscosity at 25° C. 5.3-6.8 mPas) may also be used as starting materials for the preparation of the additives according to the invention.

Known etherification (in the case where q=0) or esterification methods (in the case where q=1) may be employed for the preparation of these compounds.

The preparation of the epoxy resins according to the invention may be carried out as described below:

a) With a Solvent

The commercial epoxy resin prepared from bisphenol A and epichlorohydrin and having molecular weight of (Mₙ)_(number-average) 340 to 10,000 is dissolved in an organic solvent, such as diethyl ether, chloroform or methylene chloride. An organic base, such as pyridine or a trialkylamine, such as e.g. triethylamine, is added to this solution at −5 to 35° C. Thereafter, the slow addition of an aryl or alkyl acid chloride, dissolved in an organic solvent, such as e.g. diethyl ether, chloroform or methylene chloride is carried out at an unchanged temperature. The mixture is stirred for 0.5 to 24 hours, preferably between 1 and 6 hours. Thereafter, the precipitate formed is removed. e.g. by filtration. To remove salts, the organic phase is washed with water and the organic phase is isolated after suitable removal of water, preferably in vacuo.

b) Without a Solvent

A further preparation method is synthesis without a solvent. The advantage of this method lies in the uncomplicated working up and isolation of the product. For this, the commercial epoxy resin from bisphenol A and epichlorohydrin is heated with an aryl or alkyl acid anhydride to 80 to 200° C., preferably to a temperature between the boiling temperature of the anhydride and that of the corresponding acid, which is distilled off during the reaction. The reaction may be monitored by the amount of acid distilled off. After cooling, the resulting product is ready to use requiring no working up.

The process according to the invention for the preparation of the composition is carried out by addition of the epoxy resin to the polycarbonate. The epoxy resin may be metered in during or subsequent to the working up phase after the polymer synthesis, for example by subsequent admixing in a compounding extruder.

If compounding is chosen, the epoxy resins or mixtures thereof may be fed to the compounding extruder as the substance or as a masterbatch of 5 to 20 wt. % of epoxy resin in a polycarbonate. Further additives may optionally be added in the same processing step in a mixture with epoxy resin or the masterbatch thereof.

If metering in of the epoxy resin during the working up phase after the polycarbonate synthesis is chosen, the procedure is as described below.

The polycarbonate may be isolated from the solution by evaporation of the solvent by means of heat, vacuum or a heated entraining gas. Other methods of isolation are crystallization and precipitation. If the concentration of the polymer solution and possibly also the isolation of the polymer are carried out by distilling off the solvent, optionally by superheating and letting down, a “flash process” is referred to (see also “Thermische Trennverfahren”, VCH Verlagsanstalt 1988, p. 114); if instead of this a heated carrier gas is sprayed together with the solution to be evaporated, a “spray evaporation/spray drying” is referred to (described by way of example in Vauck, “Grundoperationen chemischer Verfahrenstechnik”, Deutscher Verlag für Grundstoffindustrie 2000, 11th edition, p. 690). All these processes are described in the patent literature and in textbooks and are familiar to the person skilled in the art.

In the case of removal of the solvent by heat (distilling off) or the industrially more effective flash process, highly concentrated polymer melts are obtained. In the known flash process, polymer solutions are repeatedly heated under a slight increased pressure to temperatures above the boiling point under normal pressure and these solutions, which are superheated with respect to normal pressure, are then let down into a vessel having a lower pressure, e.g. normal pressure. In this context it may be of advantage not to allow the concentration stages, or in other words the heating stages of the superheating, to become too large, but rather to choose a two- to four-stage process.

The residues of the solvents may be removed from the highly concentrated polymer melts obtained in this way either directly from the melt with devolatilization extruders (BE-A 866 991, EP-A 0 411 510, U.S. Pat. No. 4,980,105, DE-A 33 32 065), thin film evaporators (EP-A 0 267 025), falling film evaporators or extrusion evaporators or by friction compacting (EP-A 0 460 450), optionally also with the addition of an entraining agent, such as nitrogen or carbon dioxide, or using vacuum (EP-A 0 039 96, EP-A 0 256 003, U.S. Pat. No. 4,423,207), or alternatively also by subsequent crystallization (DE-A 34 29 960) and heating out of the residues of the solvent in the solid phase (U.S. Pat. No. 3,986,269, DE-A 20 53 876).

Granules maybe obtained either by direct spinning of the melt and subsequent granulation or by using extruders from which spinning is carried out into air or under a liquid, preferably water. If extruders are used, additives can be added to the melt upstream of the extruder, e.g. by means of static mixers or by adding the additives via a side feed extruder in the main extruder.

In this working up process, the epoxy resin, optionally with further additives, may be admixed to the polycarbonate solution to be concentrated.

If the concentration of the polycarbonate solution from the polycarbonate preparation process is carried out using a devolatilization extruder, the procedure may be as for the compounding, or the resin, which has been provided with further additives, is added by means of masterbatches via a subsidiary extruder and are fed to the devolatilization extruder.

Preferably the masterbatch comprises thermoplastic polycarbonate and 5 to 20 wt. % of the oligomeric epoxy resin according to the invention relative to the weight of the Masterbatch, whereas the polycarbonate into which the masterbatch is incorporated corresponds to the aromatic polycarbonate from the composition according to the invention. The masterbatch is incorporated into the polycarbonate that is present in form of its melt or as a solution in amounts so that the resulting composition contains 0.1 to 5 wt.-%, preferably 1 to 3 wt.-% of the epoxy resin according to the invention.

The present invention thus also provides a process, wherein

in a first step a masterbatch comprising 80 to 95 wt. % of polycarbonate A and 5 to 20 wt. % of epoxy resin of the formula (I) is prepared, and

in a second step 2 to 20 wt. % of the masterbatch from the first step is mixed with 80 to 98 wt. % of polycarbonate A1,

where polycarbonate A and polycarbonate A1 are either identical or different one from the other.

The present invention also provides a process, characterized in that an epoxy resin of the formula (I) is added during the working up phase, after the polycarbonate synthesis, to the polycarbonate solution to be concentrated, the weight ratio of polycarbonate to epoxy resin being 99.9:0.1 to 95:5, preferably 99:1 to 97:3.

The use of bisphenol A polycarbonate in the masterbatch is preferred.

If the oligomeric epoxy resin is to be incorporated into a polycarbonate solution, organic solvents, such as methylene chloride or mixtures of methylene chloride and chlorobenzene, are used for the aromatic polycarbonate. Methylene chloride is preferred as the solvent.

The compositions according to the invention may also comprise further additives (component C). Suitable additives include flameproofing agents, mold release agents, antistatics, UV stabilizers and heat stabilizers, such as are known for aromatic polycarbonates, in the conventional amounts for polycarbonate. 0.1 to 1.5 wt. %, based on the polycarbonate employed, is preferred. Examples of such additives are mold release agents based on stearic acid and/or stearyl alcohol, particularly preferably pentaerythritol stearate, trimethylolpropane tristearate, pentaerythritol distearate, stearyl stearate and glycerol monostearate, as well as heat stabilizers based on phosphanes and phosphites.

The compositions according to the invention may be processed under conventional conditions on conventional machines to give any desired shaped articles, such as sheets, films, threads, lenses, panes and apparatus housings. The polycarbonates according to the invention may be processed on all the units suitable for thermoplastic molding compositions. The polycarbonates according to the invention must be pre-dried, as is conventional for polycarbonate. The polycarbonates according to the invention may be shaped in a wide processing range by all the conventional processes, such as injection molding and extrusion, as well as injection blow molding. An overview of these processes is summarized e.g. in Kunststoffhandbuch 1992, Polycarbonate, Polyacetale, Polyester, Celluloseester, ed. W. Becker, p. 211 et seq.

The present Application also provides the polycarbonates such as are obtained by the process according to the invention and the use thereof for the production of extrudates and shaped articles, in particular those for use in the application requiring transparency, very particularly in the optical field, such as e.g. sheets, multi-wall sheets, glazing, diffuser screens, lamp covers or optical data storage media (such as audio-CD, CD-R(W), DVD, DVD-R(W), minidisks) in their various only readable or once-writable and optionally also rewritable embodiments.

The present Application also provides the extrudates and shaped articles from the polymers according to the invention.

Further uses are, for example, but without limiting the subject matter of the present invention:
1. Safety panes, which as is known are required in many areas of buildings, vehicles and aircraft, and as shields for helmets.
2. Films.
3. Blow-molded articles (see also U.S. Pat. No. 2,964,794), for example 1 to 5 gallon water bottles.
4. Light-transmitting sheets which are transparent to light, such as solid sheets or, in particular, hollow chamber sheets, for example for covering building, such as railway stations, greenhouses and lighting installations.
5. Optical data storage media, such as audio CDs, CD-R(W)s, DVDs, DVD-R(W)s, minidisks and the subsequent developments.
6. Traffic light housings or traffic signs.
7. Foams having an open or closed, optionally printable surface.
8. Threads and wires (see also DE-A 11 37 167).
9. Lighting uses, optionally using glass fibres for uses in the translucent field.
10. Translucent formulations having a content of barium sulfate and/or titanium dioxide and/or zirconium oxide or organic polymeric acrylate rubbers (EP-A 0 634 445, EP-A 0 269 324) for the production of light-transmitting and light-scattering moldings.
11. Precision injection-molded parts, such as holders, e.g. lens holders; polycarbonates are optionally used here with glass fibres and an optional additional content of 1-10 wt. % of molybdenum disulfide (based on the total molding composition).
12. Optical equipment components, in particular lenses for photographic and film cameras (DE-A 27 01 173).
13. Light transmission carriers, in particular light conductor cables (EP-A 0 089 801) and illumination strips.
14. Electrical insulating materials for electric conductors and for plug housings and plug connectors, as well as capacitors.
15. Mobile telephone housings.
16. Network interface devices.
17. Carrier materials for organic photoconductors.
18. Lighting units, floodlight lamps, diffuser screens or internal lenses.
19. Medical uses, such as oxygenators and dialyzers.
20. Foodstuff uses, such as bottles, utensils and chocolate molds.
21. Uses in the automobile field, such as glazing or, in the form of blends with ABS, as bumpers.
22. Sports articles, such as slalom poles and ski boot buckles.
23. Household articles, such as kitchen sinks, wash basins and letter boxes.
24. Housings, such as electrical distribution boxes.
25. Housings for electrical appliances, such as toothbrushes, hairdryers, coffee machines and tool machines, such as drilling, milling and planing machines and saws.
26. Washing machine portholes.
27. Protective glasses, sunglasses, corrective glasses and their lenses.
28. Lamp covers.
29. Packaging films.
30. Chip boxes, chip carrier and boxes for Si wafers.
31. Other uses, such as fattening stall doors or animal cages.

The invention is further illustrated but is not intended to be limited by the following examples in which all parts and percentages are by weight unless otherwise specified.

### EXAMPLES

Component A

Makrolon® 2808 resin (a product of Bayer MaterialScience AG, Leverkusen, Germany), a linear homopolycarbonate based on bisphenol A having a relative solution viscosity of 1.29, measured in CH₂Cl₂ as the solvent at 25° C. and a concentration of 0.5 g (100 ml).

Component B1

Preparation of a tert-butylbenzoyl-Modified Epoxy Resin

192 g of the BPA epoxy resin Epikote® 1001 (Hanf+Nelles GmbH Co KG (Germany); epoxide content 2,220 mmol/kg; viscosity at 25° C. 5.3 to 6.8 mPas) are dissolved in 250 ml methylene chloride and the solution is cooled to 0 to 5° C. 55.7 g triethylamine (0.55 mol) are added. 108.2 g (0.55 mol) tert-butylbenzoyl chloride are then added dropwise at 0 to 5° C. The mixture is warmed to room temperature and is then heated under reflux for 2 hours. It is allowed to cool and the insoluble material is filtered off. The organic phase is washed once with NaCl solution (half-saturated), once with dil. HCl solution (2 molar) and finally with water until the filtrate shows a neutral pH. The organic phase is dried over magnesium sulfate and concentrated in vacuo. The residue is dried at 70° C. under a high vacuum (mbar). 222.0 g of a yellow, vitreous solid are obtained which, according to evaluation of the ¹H-NMR data, corresponds to formula (I) where

R¹=CH₃,

R²=CH₃,

R³=4 t-Bu-C₆H₄— and

q=1.

¹H-NMR (400 MHz, CDCl₃) δ=8.0-7.90 (m), 7.50-7.40 (m), 7.15-7.05 (m), 6.85-6.75 (m), 5.79-6.60 (m), 4.35-4.25 (m), 4.20-4.10 (m), 4.0-3.90 (m), 3.35-3.25 (m), 3.90-3.80 (m), 3.75-3.65 (m), 1.65-1.55 (m), 1.40-1.25 (m).

Component B2

Preparation of an Acetyl-Modified Epoxy Resin as the Substance

49.6 g acetic anhydride are added to 200 g of the dried BPA epoxy resin Epikote® 1001 (Hanf+Nelles GmbH Co KG (Germany); epoxide content 2,220 mmol/kg; viscosity at 25° C. 5.3 to 6.8 mPas) and the mixture is stirred at 125° C. for 24 h, while the acetic acid formed is distilled off. After cooling, 220 g of a yellow solid are obtained which, according to evaluation of the ¹H-NMR data, corresponds to formula (I) where

R¹=Me,

R²=Me,

R³=Me and

q=1

¹H-NMR (400 MHz, CDCl₃) δ=7.15-7.05 (m), 6.85-6.75 (m), 5.50-5.40 (m), 4.25-4.05 (m), 4.0-3.90 (m), 3.35-3.30 (m), 2.90-2.85 (m), 2.75-2.70 (m), 2.08 (s), 1.65-1.5 (m).

### Example 1 (Comparison Example)

Makrolon 2808 is processed without additives.

The polycarbonate is extruded (ZSK 32/3; screw kneader with a screw outer diameter of 32 mm) and granulated. The granules are injection molded at a melt temperature of 295° C. and an extruder speed of 97 r.p.m. to produce sheets of 150×100×3.2 mm in optical quality.

### Example 2

Preparation of a Compound from A and B1

792.0 g polycarbonate (component A) are dissolved in 5.0 l methylene chloride. 8 g of the tert-butylbenzoyl-modified epoxy resin prepared as described above are dissolved in 50 ml methylene chloride and the solution is added to the polycarbonate solution. The mixture is concentrated and the residue is dried at 80° C. in a vacuum drying cabinet under 15 mbar for 24 hours. The solid obtained is ground and then extruded (ZSK 32/3; 2-screw kneader with a screw outer diameter of 32 mm) and granulated.

### Example 3

Incorporation of the Acetyl-Modified Epoxy Resin B2 into Polycarbonate A

40 g of the acetyl-modified epoxy resin B2 are powdered and mixed with 3,960 g polycarbonate on a gyro-wheel mixer.

This mixture is extruded (ZSK 32/3; screw kneader with a screw outer diameter of 32 mm) and granulated. The granules are injection molded at a melt temperature of 295° C. and an extruder speed of 97 r.p.m. to give sheets in a size of 150×100×3.2 mm in optical quality.

Testing of the Molding Compositions

For determination of the viscosity of the melt of the compound obtained, the zero viscosity is determined by means of a cone-plate viscometer (Physica UDS 200 rotational oscillating rheometer). A cone-plate geometry is used. The cone angle is 2° and the cone diameter is 25 mm (MK 216). The samples are pressed to thin films at 230° C. using a hot press. Isothermal frequency spectra were recorded at the stated temperatures.

The average molecular weight is determined via GPC at room temperature, calibrated for BPA-PC.

The glass transition temperature is measured in a heat flow differential calorimeter (Mettler) at 20 K/min in aluminium standard crucibles over a temperature range of from 0° C. to 250° C. in the 1st and 0 to 300° C. in the 2nd heating up. The value determined in the 2nd heating up operation is stated.

The thermoplastic flowability (MVR) (melt volume flow rate) is determined in accordance with ISO 1133.

The calorimetric evaluation is carried out in accordance with ASTM E 308, the yellowness index is determined in accordance with ASTM E 313, the haze is determined in accordance with ASTM D 1003 and the light transmission is stated for light type D65, 10° observer (ident standard color value Y).

The properties of the mixture are summarized in Table 1.

TABLE 1
Composition and properties of the molding compositions

| | Component (wt. %) | | |
|---|---|---|---|
| | 1 | 2 | 3 |
| A | 100 | 99 | 99 |
| B1 | — | 1 | — |
| B2 | — | — | 1 |
| Zero viscosity 270° C. [Pa · s] | 1,480 | 980 | 1,010 |
| MVR [cm³/10 min] | 8.9 | 12.3 | |
| Transmission [%] | 89.7 | | 89.0 |
| Haze [%] | 0.2 | | 0.9 |
| YI | 1.9 | | 2.2 |
| Tg (DSC) [° C.] | 148 | 146 | 145 |
| Mw [g/mol] | 28,200 | 27,700 | 28,200 |

Compositions 2 and 3 according to the invention show a significantly reduced zero viscosity compared with the non-modified Makrolon® 2808 (component A). Furthermore, composition 2 also shows an advantageously higher MVR value. On the other hand, the optical properties, such as the transmission of the sheets, the yellowness index (yellow value) and the haze value (cloudiness), as well as the glass transition temperature and the number average molecular weight of the molding compositions continue to be at a level comparable to that of pure Makrolon® 2808 (component A).

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. An epoxy resin conforming to formula (I) 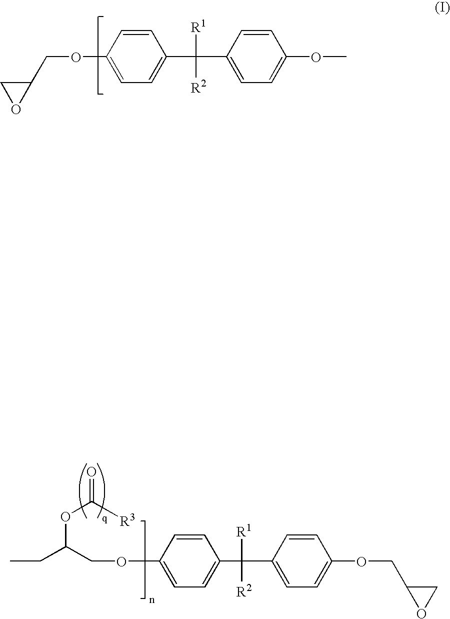
wherein
R¹, R² independently of one another denote H, a C₁-C₁₂ alkyl, phenyl or benzyl radical or, together, a cyclic C₅-C₁₂-alkyl radical
R³ represents an aryl, benzyl, linear or branched C₁-C₁₈ alkyl or cyclic C₅-C₁₂-alkyl radical,
n is 0.5 to 20 and
q is 0 or 1.

2. The epoxy resin according to claim 1, wherein q=1.

3. A thermoplastic molding composition comprising
A) 95 to 99.9% polycarbonate and
B) 0.1 to 5. % epoxy resin of claim 1, the percents, both occurrences relative to the weight of the composition.

4. The composition of claim 3, comprising
A) 97 to 99% polycarbonate and
B) 1 to 3% said epoxy resin.

5. The composition according to claim 3 further comprising at least one member selected from the group consisting of flameproofing agents, mold release agents, antistatics, UV stabilizers and heat stabilizers.

6. A process for preparing the composition of claim 3 comprising
(i) preparing a masterbatch that includes 80 to 95% of a first polycarbonate and 5 to 20% epoxy resin conforming to formula (I), said percents being relative to the weight of said masterbatch and
(ii) mixing 2 to 20. % of said masterbatch with 80 to 98% of a second polycarbonate to form a composition said percents being relative to the weight of the composition,
said first polycarbonate being identical to or different from said second polycarbonate.

7. A molded article comprising the composition of claim 3.
